(19) United States
(12) Patent Application Publication
(10) Pub. No.: US 2025/0327544 A1
(43) Pub. Date: Oct. 23, 2025

(54) PRESSURIZING GASKET

(71) Applicant: Mueller International, LLC, Atlanta, GA (US)

(72) Inventors: David Latimore Hughes, JR., Signal Mountain, TN (US); Daryl Lee Gibson, Chattanooga, TN (US); Alice Meredith Byrnes, Chattanooga, TN (US); Celia Kaye Atherton, Chattanooga, TN (US)

(21) Appl. No.: 18/639,605

(22) Filed: Apr. 18, 2024

(51) Int. Cl. F16L 55/17; F16L 55/178

(52) U.S. Cl. CPC F16L 55/1715; F16L 55/178

(57) ABSTRACT

The present invention relates to a pressurizing gasket comprising a check valve and a bladder. The bladder includes a channel connected to the check valve to accommodate a fluid. The check valve ensures one-way fluid flow into the bladder, allowing for pressurization. The pressurizing gasket provides a reliable and efficient means for controlling fluid pressure in various applications, such as sealing, hydraulic, and pneumatic systems. The combination of the check valve and bladder allows for easy and controlled pressurization, enhancing the overall performance and functionality of the pressurizing gasket.

### TECHNICAL FIELD

This disclosure relates to pressure repair clamps for repairing pipes. More specifically, this disclosure relates to a repair clamp with a pressurizing gasket.

### BACKGROUND

Pipes, particularly in water distribution systems, can develop leaks due to age, corrosion, loose joints, cracks, material defects, ground shifts, and other causes. Finding and repairing these leaks is imperative to reduce water loss, prevent infrastructure damage and contamination, and limit costs associated with lost treated water. Water leakage from distribution pipes can cause water utility problems, leading to treated water loss, increased costs, and infrastructure damage. Various methods have been employed to locate leaks, but a repair clamp is often used to repair leaking pipes when detected and located.

Although major pipe segments can be replaced when excessively leaky, this can entail expense and disruption. Generally, repair clamps provide a simpler and more affordable solution to seal leaks at joints and cracks in distribution system pipes. Conventional steel repair clamp designs comprise bolting housing sleeves around rubber wedge gaskets.

Installation of these repair clamps often has a high skill barrier and can disturb sediment inside pipes during tightening. Their grip can loosen over time, requiring re-torquing. Range limitations also often mandate expensive inventories of size-specific clamps and gaskets. Debris fouling, corrosion, and irregular pipe shapes can impede proper sealing and coupling. Thus, opportunities exist for improvements in on-site installation, sealing performance and longevity, and generality of repair clamp systems.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a pressurizing gasket including a fluid valve and a bladder including a channel in fluid communication with the fluid valve configured to receive a fluid.

In another aspect, disclosed is a sleeve including a valve bore, a plurality of circumferential hoop openings defining a plurality of edges, and a hook configured to capture an edge of the plurality of edges to capture the edge within the hook.

In another aspect, disclosed is a repair clamp including a valve; a gasket including a bladder defining a channel in fluid communication with the valve; and a sleeve extending around the pressurizing gasket including a valve bore configured to receive the valve; a circumferential hoop opening defining an edge; and a hook configured to capture the edge within the hook.

In another aspect, disclosed is a method including attaching a repair clamp to a pipe, the repair clamp including a gasket including a bladder defining a channel in fluid communication with a valve, and a sleeve extending around the gasket, the sleeve including a valve bore configured to receive the valve, a hook, and a circumferential edge; and inflating the gasket of the repair clamp.

In another aspect disclosed is a method including inserting a valve into a gasket, folding the gasket to create a seam, and vulcanizing the seam to create a pressurizing gasket.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, serve to explain various principles of the disclosure. The drawings are not necessarily drawn to scale. Corresponding features and components throughout the figures may be designated by matching reference characters for the sake of consistency and clarity.

FIG. 1 is a schematic perspective view of a pump coupled to a pipe repair clamp mounted on a pipe, the pipe repair clamp comprising a pressurizing gasket within a sleeve, in accordance with one aspect of the current disclosure.

FIG. 2 is a perspective view of the pipe repair clamp of FIG. 1.

FIG. 3 is a perspective detail view of a fluid valve and the bladder of the pipe repair clamp shown in FIG. 1.

FIG. 4 is an isolated side view of a hook and an edge of the sleeve, as shown in FIG. 1.

FIG. 5 is an isolated perspective view of a plurality of the hooks and a plurality of the edges of the sleeve, as shown in FIG. 4.

FIG. 6 is a cross-sectional side view of the bladder taken from line 6-6 in FIG. 3.

FIG. 7 is a perspective view of a folded gasket to form a bladder, in accordance with some aspects of the present disclosure.

FIG. 8 is a perspective view of the folded gasket with two sides vulcanized to form a bladder, as shown in FIG. 7.

FIG. 9 is a perspective view of the folded gasket, as shown in FIG. 7, with vulcanized sides to form the bladder shown in FIG. 3.

FIG. 10 is a detailed view of the valve ready for installation in the gasket.

FIG. 11 is a detailed outer view of a valve insertion shown in FIG. 10.

FIG. 12 is an isolated view of the gasket to form a bladder.

FIG. 13 is a cross-sectional view of the bladder and a single valve, taken along line 6-6 of FIG. 3, in accordance with some aspects of the present disclosure.

FIG. 14 is a side cross-sectional view of the bladder of FIG. 13, taken along line 14-14 of FIG. 3 and showing a channel and a waffle pattern.

FIG. 15 is a side perspective view of the pressurizing gasket showing a plurality of valves in accordance with some aspects of the present disclosure.

FIG. 16 is a side cross-sectional perspective view of the pressurizing gasket of FIG. 15 with the valves located in the cross-section of line 16-16.

FIG. 17 is a cross-sectional perspective view along line 16-16 of the pressurizing gasket showing a plurality of valves disposed in alternative locations in accordance with some aspects of the present disclosure.

FIG. 18 is a cross-sectional perspective view along line 16-16 of a pump coupled with another pressurizing gasket comprising baffles within a sleeve, in accordance with another aspect of the current disclosure.

FIG. 19 is a perspective view cross-sectional view along line 16-16 of the gasket shown in FIG. 18.

FIG. 20 is a perspective view of the gasket shown in FIG. 19, with the outer gasket removed to show the baffles.

### DETAILED DESCRIPTION

The present disclosure can be understood more readily by reference to the following detailed description, examples, drawings, and claims, as well as their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

In various aspects, a pipe repair clamp having a pressurizing gasket and associated methods, systems, devices, and various apparatuses are disclosed herein. In some aspects, the repair clamp can comprise a pressurizing gasket and a sleeve.

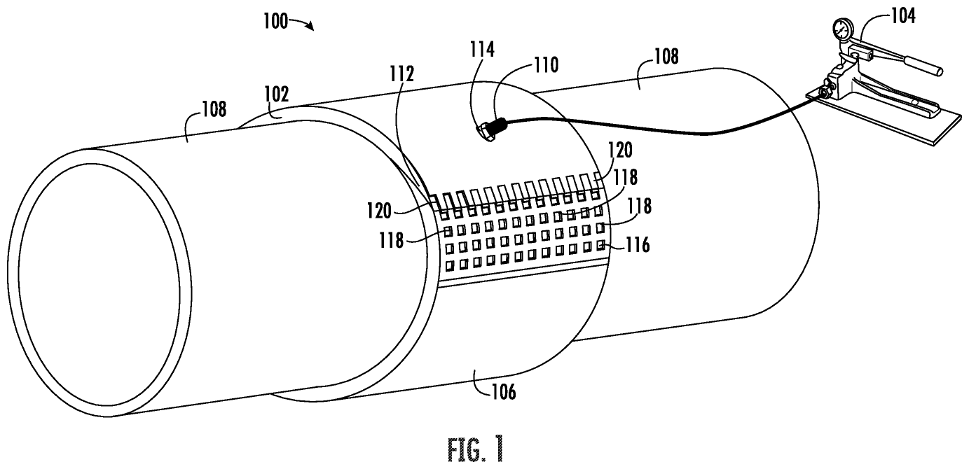

FIG. 1 shows a pipe repair clamp 100. The repair clamp 100 can comprise a sleeve 106 and a pressurizing gasket or bladder or gasket 102 coupled to a pump 104 to pressurize the gasket 102. As used herein, a bladder is a pressurizing gasket 102 comprising an inflatable internal cavity within the gasket 102. In other words, repair clamp 100 can comprise gasket 102, defining an internal cavity or channel 602 (FIG. 6). The channel 602 in gasket 102 creates an inflatable pressurizing bladder that can be located and constrained within sleeve 106. In various aspects, the sleeve 106 is structural and/or stiff and can comprise a metal or metallic construction to restrict the expansion of the pressurizing gasket 102 around a pipe 108. For example, sleeve 106 can be manufactured from a metal sheet or plate and cut and rolled into sleeve 106. In various aspects, the metal plate can be copper, bronze, steel, and/or stainless steel.

The repair clamp 100 is a device that can comprise a sleeve 106 made of a stiff material such as steel, stainless steel, metallic alloy, plastic, ceramic or a composite material like carbon fiber reinforced plastic. The sleeve 106 can capture and surround the pressurizing gasket 102. Sleeve 106 can be designed to resist the pressurization of the gasket 102 and, when pressurized the sleeve 106 compresses the pressurized gasket 102, which deforms as the pressurization inside the bladder of the gasket 102 is increased to seal any voids between the repair clamp 100 and the pipe 108. The sleeve 106 can be closed around and/or secured around the gasket 102 and/or the pipe 108 by using hook, edge, and loop fasteners, screws, adhesives, or any other suitable method. This configuration captures gasket 102 in sleeve 106 and restrains the gasket 102 against the pipe 108 when the repair clamp 100 is installed on a piping structure, e.g., to repair a leaking pipe 108.

The pressurizing gasket 102 can comprise a fluid valve or valve 110 coupled to channel 602 (FIG. 6) and configured to inflate/deflate the channel 602 to increase the pressure in the channel 602 of the gasket 102, e.g., surrounding a pipe 108 to enhance the seal between the repair clamp 100 and the pipe 108. As described below, valve 110 can be selected from various valve types. For example, valve 110 can be a one-way or two-way valve (e.g., a check valve and/or a pressure relief valve). As shown in FIG. 1, gasket 102 can form an overlap 112 at the end of the gasket where gasket 102 is wrapped around itself and surrounds the pipe 108.

The gasket 102 contains an inflatable bladder with a channel 602 connected to the fluid valve 110. The bladder is designed to receive either compressible or incompressible fluid, depending on the specific needs. An incompressible fluid offers more uniform inflation and pressurization of the gasket, while a compressible fluid can help distort the form and shape of the gasket 102 to form a seal that a traditional gasket cannot. In some aspects, a compressible fluid, such as compressed air, may be readily available at the job site, and as such, a compressible fluid may be more conveniently available for the operator to inflate the bladder. Examples of compressible fluids include air or nitrogen. In some cases, the bladder can contain an NSF-approved incompressible fluid for use in pipes carrying potable water, such as mineral oil. In some aspects, the bladder can comprise a hardenable incompressible fluid, such as an epoxy or an epoxy-type fluid, in the gasket. For example, once the incompressible fluid is injected, it can be hardened (or can harden naturally over time), cured, and/or plasticized (e.g., through a thermoplastic process) to prevent leakage or fluid seeping from within the gasket over time.

Sleeve 106 can define a valve bore 114 in the sleeve 106 to receive the valve 110 of the gasket 102. For example, valve 110 can extend through valve bore 114 to couple to pump 104 and communicate the fluid from valve 110 to channel 602 and pressurize gasket 102. Sleeve 106 can be self-fastening and can comprise a plurality of circumferential hoop openings 116, defining a plurality of edges 118. A plurality of hooks 120 on one side of sleeve 106 can capture the plurality of edges 118 on the opposite side of sleeve 106 to capture the edge 118 within the hook 120 and securely surround the sleeve 106 about the pipe 108. The circumferential hoop opening 116 can define edge 118, and the hook is configured to capture edge 118 within hook 120 to lock the repair clamp 100 over a specific diameter of pipe 108.

As shown in FIG. 1, an operator can connect pump 104 to valve 110, such as a check valve that can receive pressurized fluid from pump 104. The connection of pump 104 can inflate and/or pressurize channel 602 of gasket 102, causing it to expand and become more pressurized. Sleeve 106 then constrains the expansion of the bladder (e.g., gasket 102 comprising channel 602) and forces the bladder to deform around and pressurize on pipe 108 to form a pressurized and fluid tight seal. The plurality of circumferential hoop openings 116 on sleeve 106 can allow the sleeve 106 to be adjusted to the outer diameter of pipe 108, making the operation selective for pipes 108 with different outer diameters. For example, an operator can take sleeve 106 and/or gasket 102 configured for a pipe 108 for a particular inner diameter (e.g., a 12 inch inner diameter pipe), even though different manufacturers of 12 inch inner diameter have different schedules and therefore have different outer diameters. For example, the sleeve 106 and gasket 102 combination can be designed to accommodate all the schedules and/or outer diameters of a pipe 108 with a specific inner diameter. To accommodate different-sized pipes and installations, gasket 102 can be wrapped around itself to create the overlap 112, and both the gasket 102 and the sleeve 106 can be adjusted accordingly.

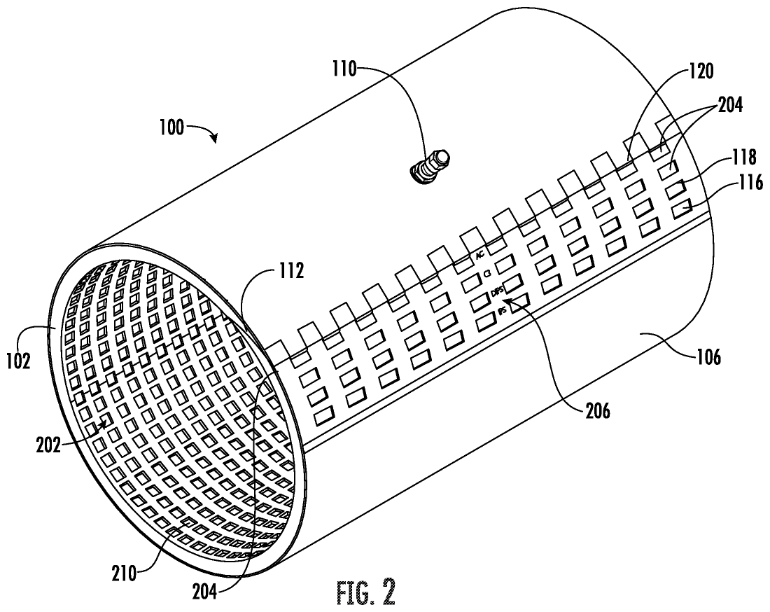

FIG. 2 is a perspective view of the repair clamp 100 of FIG. 1, with pipe 108 removed to show details of the bladder and a waffle pattern 202 formed on a pipe-facing surface 210 of the gasket 102. The bladder differentiates gasket 102 comprising a channel 602 (e.g., a bladder) from a conventional gasket without a channel 602 or bladder. As shown in FIG. 1, the pump 104 can inflate the bladder in gasket 102 (e.g., channel 602) surrounding the pipe 108 to pressurize and secure the seal formed by the repair clamp 100 over an outer diameter of the pipe 108.

It should be noted that the inverse process is also available. The gasket 102 can be pressurized like a stent on the inside of pipe 108 to seal the internal diameter of pipe 108. In this configuration, the sleeve 106 has a smaller inner diameter than either the pipe 108 or the gasket 102. In addition, in various aspects, pressurizing gasket 102 can pressurize and seal against other components and/or pipes 108, such as valves, couplings, and/or other piping components. As used herein, pipe 108 is used generally to convey any piping components, such as valves, couplings, caps, and/or clamps.

FIG. 2 shows additional features of gasket 102 that further enhance the seal created when the bladder is inflated, and gasket 102 forms a seal on pipe 108. The waffle pattern 202 can be formed on gasket 102 and compressed on the outer diameter of pipe 108 to enhance the seal. Waffle pattern 202 comprises a series of voids surrounded by walls. As shown, waffle pattern 202 is a square or rectangular pattern, but other patterns of voids surrounded by walls are contemplated, such as circular voids and/or walls. Waffle pattern 202 can function to compartmentalize any leaks or breaks in the seal between gasket 102 and pipe 108. Specifically, if there is a break in pipe 108 and a working fluid, e.g., water, within pipe 108 escapes to the gasket 102, the pockets or voids within the waffle pattern 202 can limit and seal the leak between the pipe 108 and the sleeve 106. That is, the outer boundaries of the waffle pattern 202 can isolate, surround, and/or compartmentalize the leak in the circumferential and axial directions where the boundaries are compressed against the pipe 108.

Waffle pattern 202 can be a smooth surface or may not be used in various aspects. For example, pipe-facing surface 210 can be smooth and/or not comprise a waffle pattern 202 in some aspects.

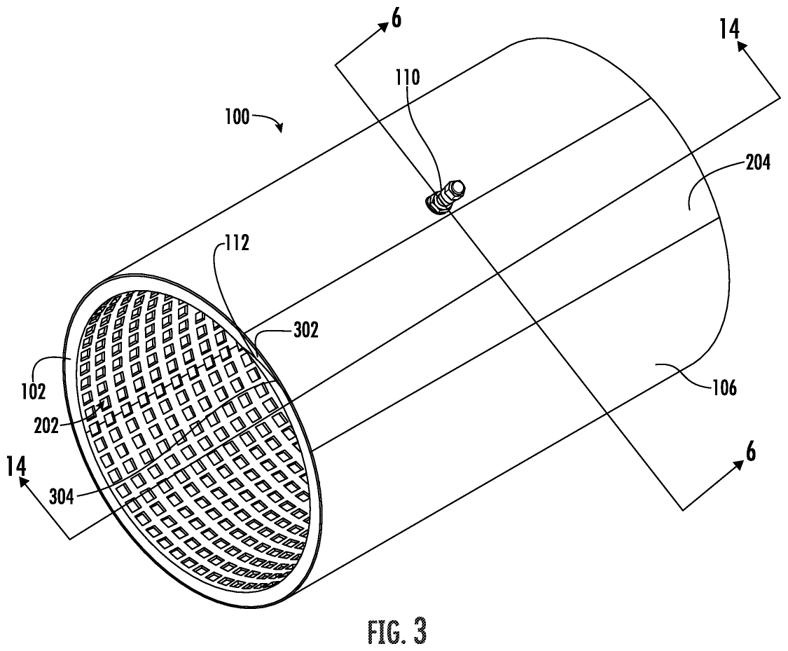

In some aspects, a plate 204 (also shown in FIG. 3) can be disposed under the hook 120 and edge 118 joint on the sleeve 106 to protect the gasket 102 from accidental cuts or punctures, e.g., from the end of hook 120 puncturing gasket 102. Plate 204 can be placed between sleeve 106 and gasket 102 to protect gasket 102 from being punctured, damaged, or losing pressure. In various aspects, plate 204 can be coupled or secured to an inner surface of sleeve 106 to orient plate 204 relative to the hooks 120 on sleeve 106. Similarly, plate 204 can distribute hoop and axial forces generated during pressurization more equally across sleeve 106 and/or gasket 102.

The sleeve 106 can include etched pipe outer diameter sizes or indicators 206 on an outer surface to indicate a circumferential hoop opening 116 for an outer pipe diameter size. In general, pipe 108 is generally referenced by a nominal diameter and a schedule; e.g., a 12-inch pipe refers to a pipe with a 12-inch inner diameter, and the schedule refers to the thickness of the pipe. Thus, a 12-inch pipe can have several different thicknesses and outer diameters. Therefore, an operator in the field can need a different-sized repair clamp 100 for the same nominal diameter pipe 108. One enhancement of the present repair clamp 100 is that both sleeve 106 and gasket 102 can expand/contract to service any variations for the nominal pipe diameter. Sleeve 106, comprising hooks 120 and edges 118, and overlap 112 of gasket 102 facilitate that same repair clamp 100 being adjusted and expanded or contracted to the suitable outer diameter for any scheduled size of the nominal diameter pipe 108. The ability of the sleeve 106 and the gasket 102 to expand or contract to service different schedules of the same nominal size facilitates the stockpiling and repair of parts the operator needs to repair a leaky or faulty pipe 108.

As shown in FIGS. 1 and 2, fluid valve 110 can be a one-way or a two-way valve 110, e.g., comprising both a check valve capable of receiving fluid to pressurize the bladder in gasket 102 and a pressure relief valve capable of removing fluid and depressurizing the bladder and depressurizing gasket 102. As used herein, check valve is a valve 110 that receives fluid to pressurize channel 602. A pressure relief valve is a valve 110 that can be opened to remove fluid from channel 602. A two-way valve is a valve 110 that comprises both a check valve to pressurize channel 602 and a pressure relief valve to depressurize channel 602.

FIG. 3 is a perspective detail view of the fluid valve 110 and the pressurizing gasket 102 and clearly illustrates plate 204 shown in FIG. 2. As described above, plate 204 can prevent hook 120 and/or edges 118 from puncturing gasket 102, e.g., when sleeve 106 is mounted on and/or surrounds gasket 102. This way, sleeve 106 and gasket 102 can accommodate pipes 108 with different outer diameters. For example, a single-sized gasket 102 and sleeve 106 can be used for any schedule (or outer diameter) of pipes 108 with matching inner diameters.

In some aspects, plate 204 can be coupled to an end of sleeve 106 and/or gasket 102, and the operator wraps a first side 302 of gasket 102, e.g., comprising plate 204 over or under the opposite end or second side 304 of gasket 102 to make overlap 112. Similarly, cinching sleeve 106 can cause overlap 112 in gasket 102. That is, by joining at least one side of plate 204 to gasket 102 or sleeve 106, when gasket 102 is rolled up inside sleeve 106, plate 204 is oriented relative to hooks 120 and edges 118 on sleeve 106. In this way, the operator can safely slide the hooks 120 and at least part of the sleeve 106 over the plate 204. In some aspects, plate 204 can be coupled to sleeve 106 (e.g., spot welded or joined) so that the operator does not need to fidget with plate 204 when installing sleeve 106. Similarly, plate 204 can be coupled to gasket 102. Plate 204 can be embedded inside gasket 102, joined to (e.g., welded, sewn, or melted into) gasket 102, and/or friction fit within gasket 102 to make gasket 102 and plate 204 function like a single unitary body. In other aspects, plate 204 can be a separate component installed and placed by the operator to control the overlap 112 and form a tailored joint on the repair clamp 100.

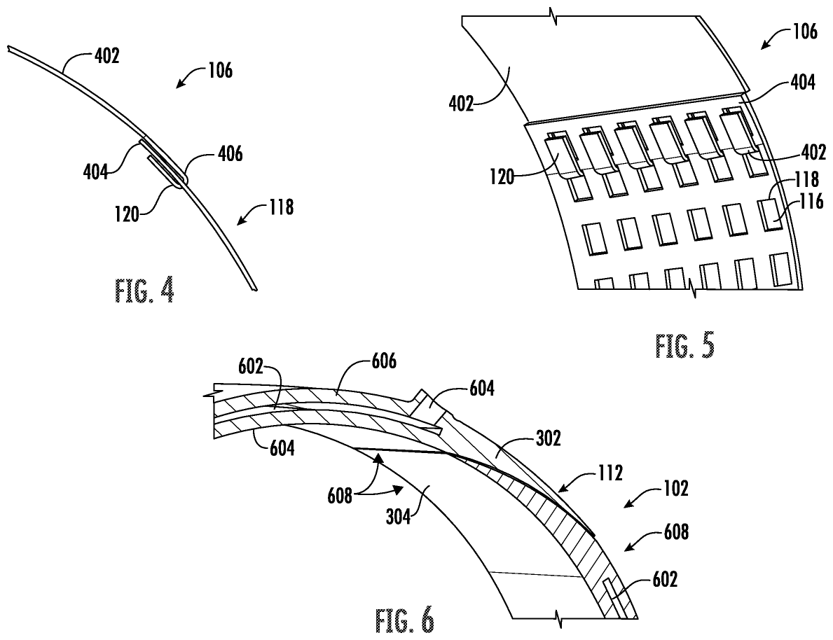

FIG. 4 is an isolated side view of the sleeve 106. FIG. 5 is an isolated perspective view of the hooks 120 and edges 118 formed on the sleeve 106. FIGS. 4 and 5 show that sleeve 106 defines a rigid (e.g., metallic) sidewall 402 terminating at a first end 404 and a second end 406. The first end 404 terminates on the first side of sidewall 402, comprising a plurality of edges 118 on sleeve 106, as shown in FIG. 1. Similarly, the second end 406 comprises the hook 120 on a second end 406 of sidewall 402. In this way, the diameter of the sidewall 402 and sleeve 106 can be modified to accommodate different outer diameters of pipe 108. For example, one sleeve 106 can be designed to accommodate a variety, or all, different schedules of an inner diameter of pipe 108.

Sleeve 106 can be manufactured from a variety of materials and can be manufactured or comprise a hardened plastic or metal material. For example, sleeve 106 can be formed from a flat metal sheet that is cut and rolled into a sidewall 402. For example, sleeve 106 and/or gasket 102 can be rolled into a conical shape, e.g., to conform sleeve 106 and/or gasket 102 to a cylindrical shape that fits on a specific outer diameter of pipe 108 on a mandrel 1202 (FIG. 12). For example, sleeve 106 is formed from a metallic sidewall 402 comprising a metal material and/or metallic alloy comprising steel, stainless steel, bronze, copper, and/or other hardened and ductile/malleable metals. Sleeve 106 can include plate 204 (shown in FIG. 3) attached to an inner diameter of sleeve 106 to protect gasket 102 from puncture by hooks 120 and/or edges on sleeve 106.

FIG. 6 is a cross-sectional side view of the pressurizing gasket 102 comprising the channel 602 forming an inflatable bladder. Gasket 102 comprises channel 602, which receives a fluid to inflate/deflate the bladder and pressurize the repair clamp 100. Gasket 102 can be an inner rubber sheet 604 and/or an outer rubber sheet 606. At least one inner rubber sheet 604 and/or the outer rubber sheet 606 can comprise the waffle pattern 202 to seal the gasket 102 against the inner/outer surface of pipe 108. As shown in FIG. 6, gasket 102 can comprise inner rubber sheet 604 coupled to outer rubber sheet 606, e.g., through a vulcanization process to seal the ends of the sheets to one another.

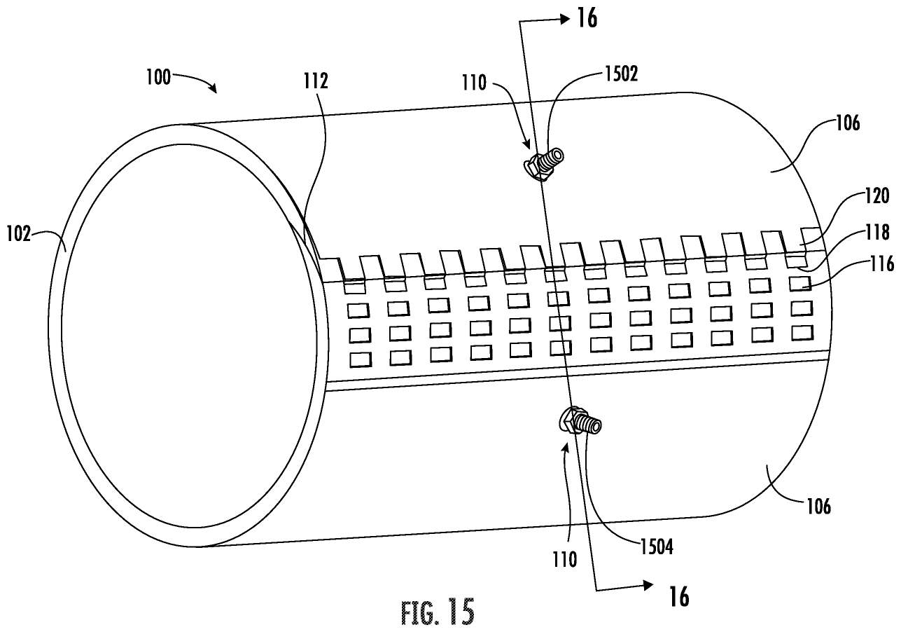

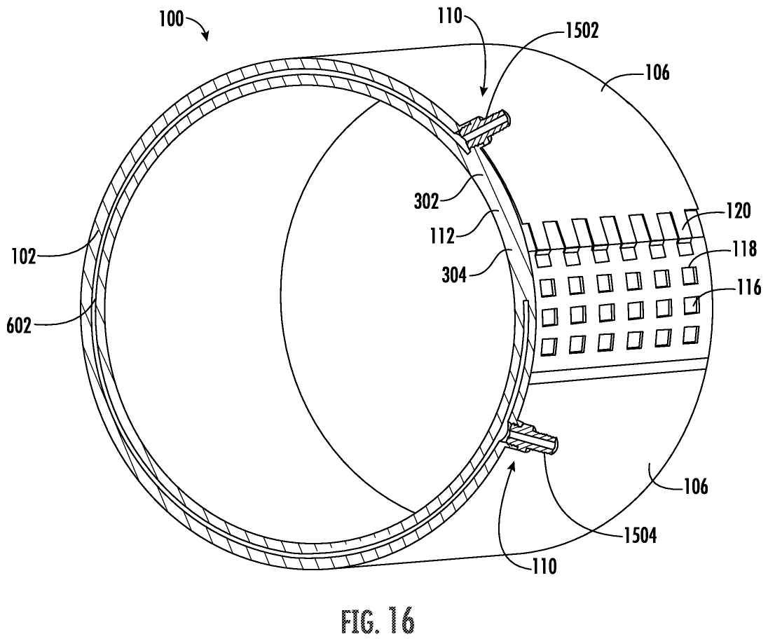

In various aspects, sleeve 106 surrounds and pressurizes gasket 102 when fluid is inserted into gasket 102 through a fluid valve 1502 (shown in FIG. 15, e.g., a check valve), and channel 602 coupled to the fluid valve 1502 is inflated. The bladder-like expansion of channel 602 facilitates the formation of seams and seals about gasket 102 by pressurizing gasket 102 against the surface of pipe 108. For example, repair clamp 100 can comprise a bladder containing an incompressible fluid captured between inner rubber sheet 604 and outer rubber sheet 606. Inner rubber sheet 604 and outer rubber sheet 606 can be vulcanized at a perimeter 608 of the inner rubber sheet 604 and the outer rubber sheet 606 to form channel 602.

A valve bore 610 can connect valve 110 to the gasket 102, e.g., either the inner rubber sheet 604 and/or the outer rubber sheet 606. Valve bore 610 can be a patch of rubber that is attached to an inner surface of gasket to extend the valve 110 through gasket (e.g., the patch as shown in FIG. 10 can be adhered to the gasket to extend valve 110 from channel 602 to the outer environment).

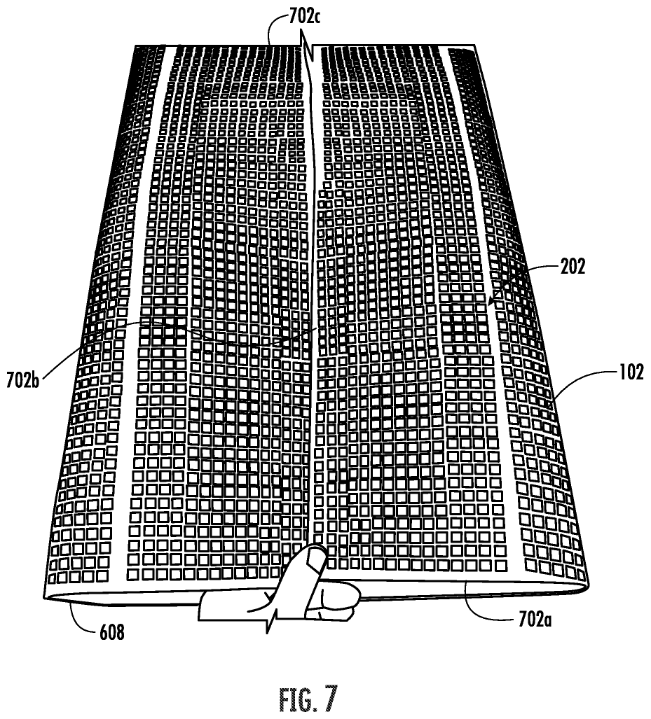

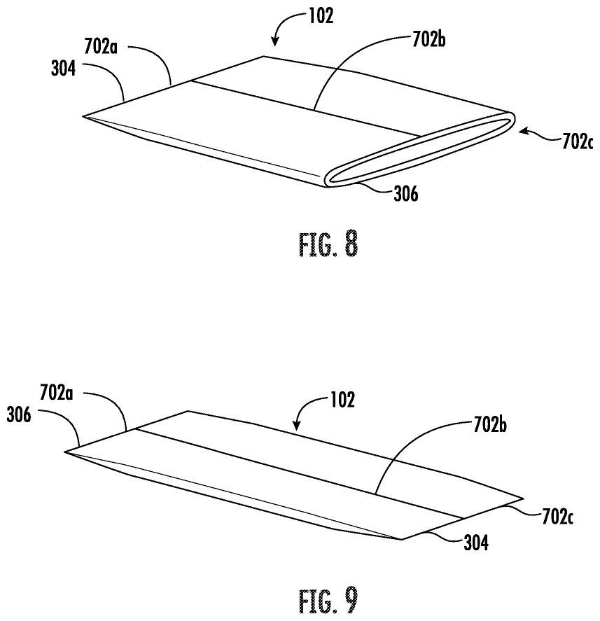

FIG. 7 is a perspective view of a folded gasket 102 forming a bladder. In some aspects, the pressurizing gasket 102 comprises an integral or monolithic one-piece pressuring bladder. Similarly, a non-bladder rubber gasket 102 can be folded and sealed (e.g., vulcanized at the edges) to form a pressurizing gasket 102. The gasket 102 can include three seams 702a,b,c that are folded and adhered (e.g., vulcanized) to form the bladder and channel 602 within the pressurizing gasket 102. In various aspects, valve 110 can be inserted through the rubber sheet (e.g., non-bladder rubber gasket), and the three seams are vulcanized to form channel 602. Forming the pressurizing gasket 102 can comprise inserting valve 110 through a rubber sheet and folding a rubber sheet (e.g., a non-pressurizing gasket). Then the rubber sheet is folded to form seams 702a,b,c, the seams 702 can be adhered to each other (e.g., vulcanized and/or melted together) to form the channel 602 in the gasket 102. In this way, the perimeter 608 and/or one or more seams 702 can be vulcanized to form the bladder and channel 602 in a non-pressurizing gasket and convert it into the pressurizing gasket 102.

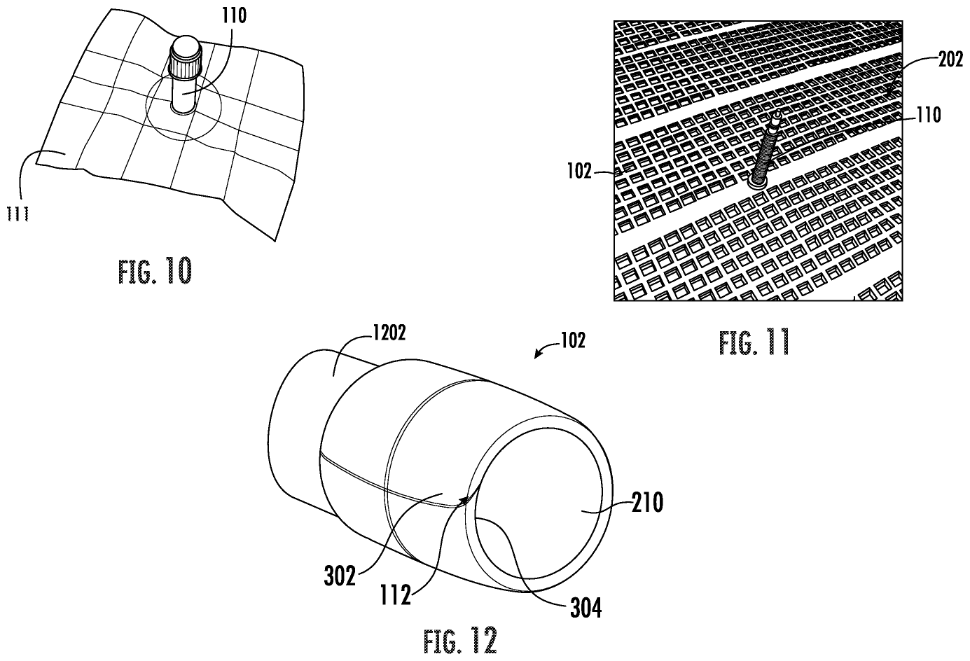

FIGS. 7-12 disclose methods for using and manufacturing the pressurizing gasket 102. The method of manufacturing pressurizing gasket 102 comprises folding a rubber sheet to form one or more seams 702 on the rubber sheet of gasket 102 (FIG. 7). Seem 702 can then be vulcanized to create a pressurizing gasket 102 and vulcanize the seams 702. For example, FIG. 8 shows two of the three-seamed gasket 102 being vulcanized. In this way, an insulative layer (not shown) in FIG. 8 can be removed from channel 602 before vulcanizing the last seam 702c, shown in FIG. 9. Valve 110 can be inserted into the rubber sheet 604 or 606, e.g., before or after folding, to form at least one of a fluid valve 1502 and/or pressure relief valve 1504 in the gasket 102, as shown in FIGS. 10 and 11.

FIG. 10 shows the valve 110 configured for installation within a gasket 102 (FIG. 8). For example, valve 110 can comprise a patch 111 shown in FIG. 10 bonded to a side of gasket 102 (e.g., an inner surface of gasket 102) and/or adhered or bonded to gasket 102. As illustrated, patch 111 is a component of valve 110 that can be mounted on and/or bonded to an inner surface of gasket 102 to insert and join valve 110 to the gasket 102. In other aspects, valve 110 can be a modular assembly with gasket 102. In various aspects, valves 110 can be of one or more types or classifications. For example, valve 110 can be a Presta valve 110, a Schrader valve 110, and/or another configuration of a check valve and/or pressure relief valve. Similarly, valve 110 can be a two-way valve.

FIG. 12 is an isolated view of the gasket 102 after forming around a mandrel 1202 to form a cylindrical bladder. The gasket 102 can be formed and/or folded around the heated mandrel 1202 to shape and form the gasket 102 in a cylindrical configuration, e.g., to fit over or within pipe 108. For example, the first side 302 of the gasket 102 can be rolled over the second side 304 of the gasket 102 to create overlap 112, which can be set in a thermoplastic set on mandrel 1202 so that gasket 102 retains overlap 112 when removed from sleeve 106. In some aspects, the gasket 102 can be folded with the waffle pattern 202 on the rubber sheet facing outward (or axially inward relative to the axis of the pipe 108), e.g., away from channel 602. This way, the gasket 102 is formed with the waffle pattern 202 facing away from channel 602 to form a sealing surface against an adjacent pipe 108. The vulcanization of the ends (or seams 702a and 702c) can form the first side 302 and second side 304 at an opposite end, which are rolled over each other to form the overlap 112.

Regarding FIGS. 7-12, in various aspects, the method of manufacturing gasket 102 can further comprise cutting the gasket 102 to define sides (e.g., seams 702) of different-sized gaskets 102 that is vulcanized to seal an inner cavity or channel 602 of the bladder forming the pressurizing gasket 102.

The method of using gasket 102 can comprise attaching repair clamp 100 (e.g., with sleeve 106 surrounding pressurizing gasket 102) to pipe 108. The repair clamp 100 can comprise the pressurizing gasket 102, which can be pressurized and captured within sleeve 106 to form a fluid-tight and pressurized seal between repair clamp 100 and pipe 108. That is, the bladder and/or channel 602 within gasket 102 defines and characterizes the pressurizing gasket 102. When the pressurizing gasket 102 is coupled to the valve 110 the sleeve 106 can extend around or surround the gasket 102 and include valve bore 114 configured to receive the valve 110, hook 120, and/or circumferential edge 118, as shown in FIG. 1. The operator can then use pump 104 to inflate or pressurize the gasket 102 of the repair clamp 100 and seal the gasket 102 to the pipe 108 and/or pipe surface.

The gasket 102 can be inflated and/or deflated. For example, gasket 102 can be deflated to remove fluid (e.g., incompressible or compressible) before inflating gasket 102 with compressible/incompressible fluid to pressurize gasket 102 relative to pipe 108. The repair clamp 100 can be attached or coupled to pipe 108 and attaching or coupling the repair clamp 100 to the pipe 108 can comprise wrapping gasket 102 around pipe 108 and inflating gasket 102 after coupling the plurality of hooks 120 to the plurality of edges 118 about the circumference of sleeve 106. In some aspects described above, positioning and/or adjusting plate 204 between sleeve 106 and gasket 102 can protect gasket 102 from puncture by sleeve 106.

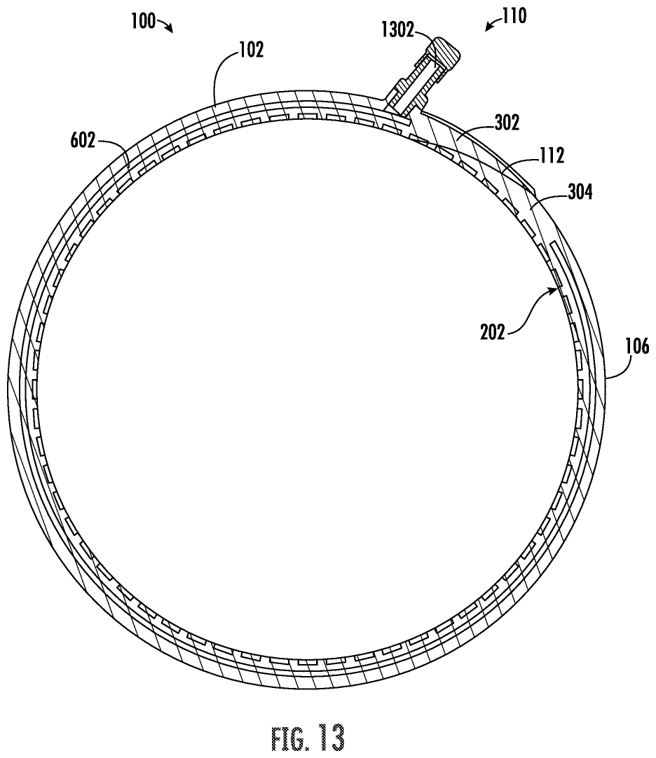

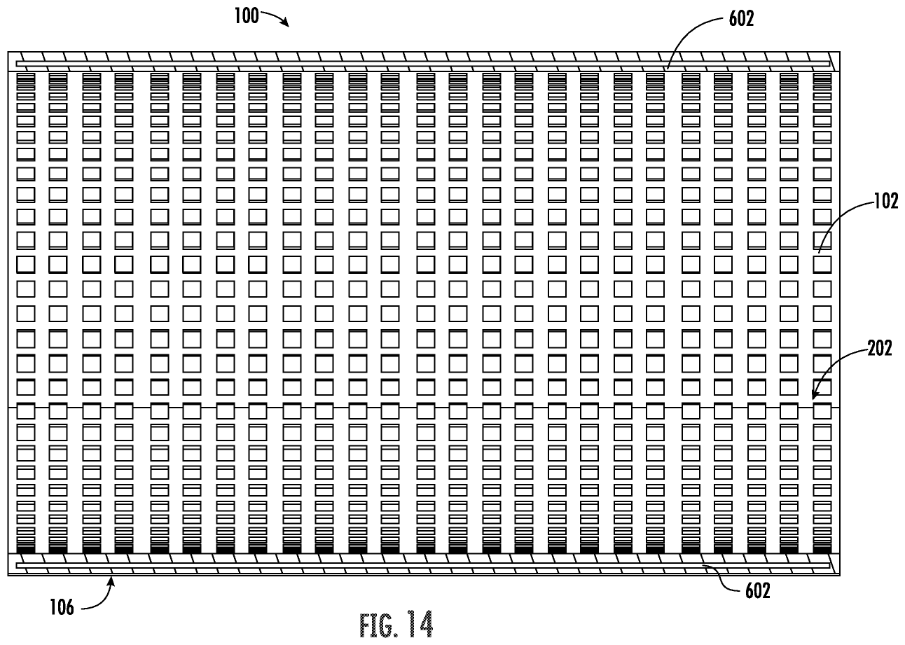

FIG. 13 is a cross-sectional view of the inflatable bladder defining gasket 102. FIG. 14 is a side cross-sectional view of the gasket 102 of FIG. 13, showing channel 602 and waffle pattern 202. As shown in FIGS. 13-14, a single two-way valve 1302 can be installed as both a check valve and a pressure-relief valve. As shown in FIG. 13, two-way valve 1302 is both an input and an output to channel 602. In various aspects, the channel 602 can be a closed loop. The inlet to channel 602 is the outlet of channel 602, and valve 110 is a two-way valve 1302. In such a configuration, fluid valve 1302 includes both the check valve and pressure relief valve functions, and valve 1302 is disposed at one location in gasket 102 to serve as both the inlet and the outlet of channel 602.

The cross-sections and perspective views shown herein may be simplified. That is, some cross-sectional views of valves 110 can show unobstructed passageways through the valve 110. In some aspects, the valves 110 can comprise internal components for blocking fluid flow and/or communication therethrough. Similarly, pipe 108 can comprise other pipe fittings, such as valves, fittings, joints, and other fluid blocking caps or fittings. Also, in various embodiments, the location of a cross-section may be approximate and views of the valves 110 may differ from one view in one figure relative to a similar view in another figure.

As described with reference to FIG. 13, valves 110 (e.g., either or both valves in FIGS. 15-17) can be two-way valves 1302. In other aspects, each valve 110 can be a one-way valve 110. For example, FIG. 15 shows a side perspective view of the pressurizing gasket 102 comprising a plurality of valves 110. Valves 110 can be one-way, e.g., comprising separate valves 110 at an inlet valve 1502 and/or a pressure relief valve 1504.

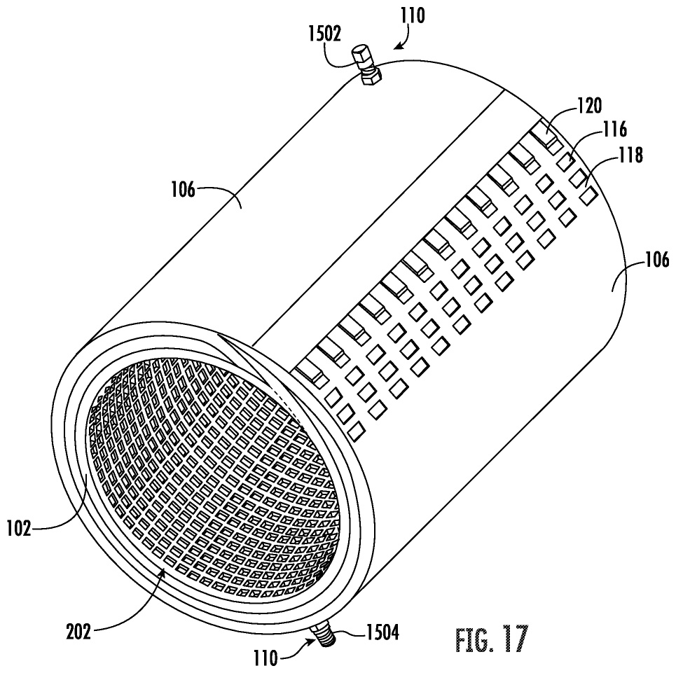

FIG. 16 is a side cross-sectional perspective view of the pressurizing gasket 102. FIG. 17 is a perspective view of the pressurizing gasket 102, showing a plurality of valves 110 disposed in different locations than those shown in FIGS. 15-16.

With reference to FIGS. 15-17, gasket 102 can comprise a plurality of valves 110 (e.g., one-way valves 110 such as 1502 and 1504 and/or two-way valves 110 such as 1302), and each valve 110 can be a one-way or two-way valve 110. For example, each valve 110 can be limited to either the inlet valve 1502 (e.g., a check valve) and/or the pressure relief valve 1504 used to deflate or depressurize channel 602. For example, gasket 102 can comprise a check valve as the inlet valve 1502 in fluid communication with an inlet of channel 602, and the bladder can comprise pressure relief valve 1504, located at and in fluid communication with an outlet of channel 602.

The inlet valve 1502 can be fluidly connected to bladder and configured to communicate fluid (e.g., incompressible and/or compressible fluid) to channel 602 of gasket 102 to pressurize the bladder. Similarly, a bleed valve or pressure relief valve 1504 can be fluidly connected to the outlet of the bladder. Pressure relief valve 1504 can be configured to release the incompressible/compressible fluid from the bladder to depressurize the gasket 102 and/or remove the repair clamp 100. The check valve 1502 can receive the fluid inserted into the bladder to pressurize the gasket 102, and the bleed valve or pressure relief valve 1504 removes the fluid from the bladder to depressurize the gasket 102. For example, check valve 1502 can insert a working fluid (e.g., a compressible and/or incompressible fluid) and the pressure relief valve 1504 can bleed air. In various aspects, pressure relief valve 1504 can remove air prior to and/or after the insertion of a working fluid at check valve 1502, and/or pressure relief valve 1504 can be used to remove the working fluid injected at check valve 1502. Gasket 102 can be pumped and/or pressurized at check valve 1502 and depressurized (e.g., bled, released, and/or de-inflated) at pressure relief valve 1504. In other aspects, gasket 102 can comprise a two-way valve 1302 and a pressure relief valve 1504, with two-way valve 1302 allowing insertion and removal of the working fluid and the pressure relief valve 1504 allowing for air to be bled from the gasket 102 before or after insertion of the working fluid.

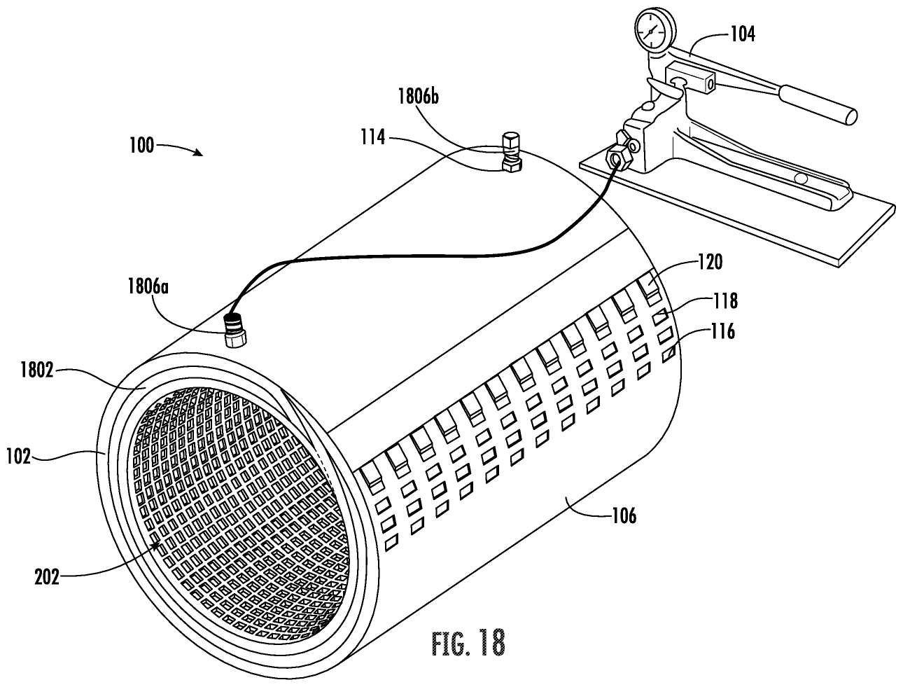

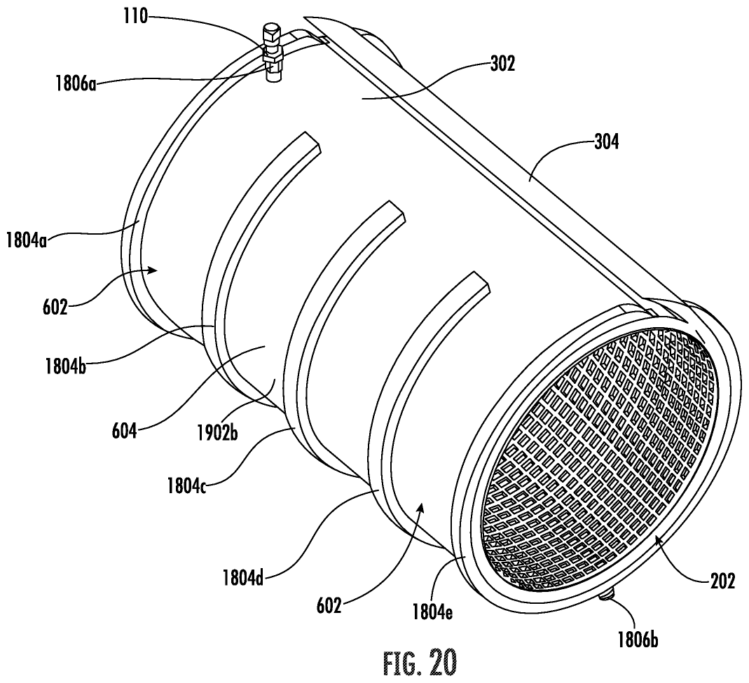

FIGS. 18-20 show another perspective view of pump 104 coupled with another pressurizing gasket 1802. Pressurizing gasket 1802 can be the same as or similar to gasket 102, except that pressurizing gasket 1802 comprises various baffles 1804 (shown in FIG. 20) that form channels 602 within gasket 1802.

In various embodiments, as shown in FIGS. 15-17, two valves 110 are used to inflate and deflate the bladder. FIG. 18 similarly shows two one-way valves that are used to insert the working fluid and bleed any residual air. For example, where valve 110 is a one-way valve, two valves 110 can be used to first insert the working fluid (e.g., check valve 1806a) and second to bleed the air (e.g., pressure relief valve 1806b). The location of the check valve 1806a and/or pressure relief valve 1806b can be oriented to bleed air at the top of the repair clamp 100 and/or sleeve 106. In various aspects, the location of the pressure relief valve 1806b can be on the same side or opposite sides of the check valve 1806a, e.g., as shown in various positions of FIGS. 15-18. Sleeve 106 can be modified with various holes or valve bores 114 to receive different types, sizes, or qualities of valve 110.

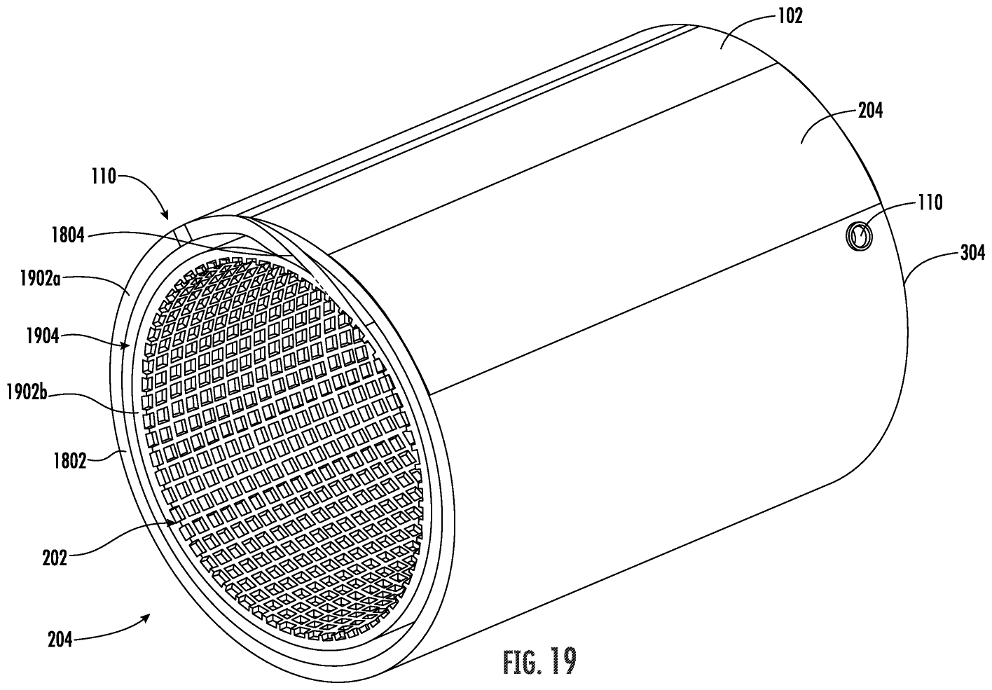

FIGS. 19-20 show a perspective view of gasket 1802, with baffles 1804 coupling an outer sheet 1902a and an inner sheet 1902b to form pressurizing gasket 1802. FIG. 20 shows the outer sheet 1902a removed to show the formations of various baffles 1804 between the outer and inner sheets 1902a,b that can be vulcanized to a side of gasket 1802 to form channels 602 around the gasket 1802 prior to joining the inner and outer layers. That is, baffle 1804 can be vulcanized and/or adhered to the inner layer and/or outer layer (e.g., inner and outer sheets 1902a,b) to create channels 602 through and about the pressurizing gasket 1802 when the inner and outer layers are coupled, adhered, sealed, and/or joined (e.g., through vulcanization or a melting process). In some aspects, various baffles 1804a and 1804e can be used to seal ends of the gasket 1802, and internal baffles 1804b,c, and d can be used to orient fluid channels 602 around the pressurizing gasket 1802.

Baffles 1804a,b,c,d, and/or e can be vulcanized to an inner surface of a monolithic rubber sheet 604 and then folded and vulcanized at seams 702a,b,c as described above with reference to FIG. 7. Similarly, baffles 1804 can be joined or adhered to the inner and/or outer sheet(s) 1902a,b, and sealed by joining the sheets together, e.g., through a melting or vulcanization process. In this way, the bladder can define inner and outer layers 1904a,b or sides, and the channel 602 can defines a loop that extends from the first side 302 to the second side 304 and from the second side 304 to the first side 302.

The description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials and processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B,” as used herein, means “only A, only B, or both A and B,” while the phrase “one of A and B” means “A or B.”

As used herein, unless the context clearly dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the seat nearest to and occupied by a user of a seat; “rear” is that end of the seat that is opposite or distal the front; “left” is that which is to the left of or facing left from a person sitting in the seat and facing towards the front; and “right” is that which is to the right of or facing right from that same person while sitting in the seat and facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements, and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A pressurizing gasket comprising:
a fluid valve; and
a bladder comprising a channel in fluid communication with the fluid valve and configured to receive a fluid.

2. The pressurizing gasket of claim 1, wherein:
the fluid valve is configured to communicate fluid to the channel to pressurize the bladder; and
the fluid valve is a two-way valve configured to release a fluid from the bladder.

3. The pressurizing gasket of claim 1, wherein the channel is a closed loop and an inlet to the channel is an outlet of the channel, and wherein the fluid valve comprises a pressure relief valve and is disposed in the inlet and in the outlet of the channel.

4. The pressurizing gasket of claim 1, wherein the fluid valve is a check valve located at an inlet of the channel, and the bladder further comprises a pressure relief valve located at an outlet of the channel.

5. The pressurizing gasket of claim 1, wherein the bladder comprises an inner rubber sheet and an outer rubber sheet, the inner rubber sheet coupled to the outer rubber sheet and vulcanized at a perimeter of the inner rubber sheet and the outer rubber sheet to form the channel.

6. The pressurizing gasket of claim 5, wherein the bladder defines a first side and a second side, and the channel defines a loop that extends from the first side to the second side and from the second side to the first side.

7. The pressurizing gasket of claim 5, wherein at least one of the inner rubber sheet and the outer rubber sheet comprises a waffle pattern.

8. The pressurizing gasket of claim 1, wherein the bladder is a monolithic one-piece pressurizing bladder comprising three seams, wherein the three seams are vulcanized.

9. The pressurizing gasket of claim 8, wherein the fluid valve is a first fluid valve and the pressuring bladder further comprises a second fluid valve, wherein the first fluid valve is configured to receive the fluid inserted into the bladder, and the second fluid valve is configured to remove the fluid from the bladder.

10. The pressurizing gasket of claim 8, wherein the bladder is configured to surround a pipe, such that the bladder overlaps itself on opposing ends of the bladder and the bladder is configured to be inflated over an outer diameter of the pipe.

11. The pressurizing gasket of claim 10, wherein the bladder further comprises a waffle pattern on an inner surface of the bladder configured to be compressed on the outer diameter of the pipe.

12. The pressurizing gasket of claim 1, further comprising the fluid received in the bladder, wherein the fluid is an incompressible fluid.

13. The pressurizing gasket of claim 12, wherein the incompressible fluid received in the bladder is NSF-approved for a pipe carrying potable water.

14. The pressurizing gasket of claim 13, wherein the fluid is a mineral oil.

15. A sleeve comprising:
a valve bore;
a plurality of circumferential hoop openings defining a plurality of edges; and
a hook configured to capture an edge of the plurality of edges to capture the edge within the hook.

16. The sleeve of claim 15, wherein the sleeve comprises a stainless steel and the sleeve further comprises a plate on an inner diameter of the sleeve.

17. The sleeve of claim 15, wherein the sleeve comprises etched pipe sizes on an outer surface to indicate a circumferential hoop opening for an outer pipe diameter size.

18. A repair clamp comprising:
a fluid valve;
a gasket comprising a bladder defining a channel in fluid communication with the fluid valve; and
a sleeve extending around the gasket comprising a valve bore configured to receive the fluid valve.

19. The repair clamp of claim 18, wherein the sleeve further comprises a circumferential hoop opening defining an edge and a hook configured to capture the edge within the hook.

20. The repair clamp of claim 18, further comprising a plate disposed between a seam in the sleeve and the gasket.

21. The repair clamp of claim 18, wherein the fluid valve is a two-way valve capable of pressurizing the bladder and depressurizing the bladder.

22. The repair clamp of claim 18, wherein the bladder comprises an incompressible fluid captured between an inner rubber sheet and an outer rubber sheet, and the bladder is vulcanized at a perimeter of the inner rubber sheet and the outer rubber sheet to form the channel.

23. The repair clamp of claim 22, wherein the fluid valve is a two-way valve, the sleeve comprises a stainless steel, and the bladder comprises a waffle pattern defining the channel within the bladder.

24. The repair clamp of claim 23, wherein the fluid valve extends through a hole defined in the sleeve.

25. A method comprising:
attaching a repair clamp to a pipe, the repair clamp comprising a gasket comprising a bladder defining a channel in fluid communication with a valve, and a sleeve extending around the gasket, the sleeve comprising a valve bore configured to receive the valve; and
inflating the gasket of the repair clamp.

26. The method of claim 25, wherein the method further comprises deflating the gasket to remove an incompressible fluid prior to inflating the gasket with a fluid.

27. The method of claim 25, wherein attaching the repair clamp to the pipe comprises wrapping the gasket around the pipe and coupling a hook to a circumferential edge in the sleeve.

28. The method of claim 27, wherein attaching the repair clamp further comprises positioning a plate between the sleeve and the gasket.

29. The method of claim 28, wherein inflating the bladder of the gasket the gasket with an outer surface of the pipe.

30. A method comprising:
inserting a valve into a gasket;
folding the gasket to create a seam; and
vulcanizing the seam to create a pressurizing gasket.

31. The method of claim 30, further comprising forming the gasket around a heated mandrel, wherein the gasket is folded with a waffle pattern facing inward.

32. The method of claim 30, further comprising cutting the gasket to define sides of the gasket that are vulcanized to seal an inner cavity of the pressurizing gasket.

33. The method of claim 30, further comprising positioning the gasket within a sleeve and extending the valve through a hole in the sleeve.
